(19) United States
(12) Patent Application Publication
(10) Pub. No.: US 2026/0238496 A1
(43) Pub. Date: Aug. 13, 2026

(54) Private Access for Third-Party Applications

(71) Applicant: Zscaler, Inc., San Jose, CA (US)

(72) Inventor: Mohammad Aamir, Seattle, WA (US)

(73) Assignee: Zscaler, Inc., San Jose, CA (US)

(21) Appl. No.: 19/049,530

(22) Filed: Feb. 10, 2025

(51) Int. Cl. H04L 9/32

(52) U.S. Cl. CPC H04L 9/3263; H04L 9/3213; H04L 9/3242

(57) ABSTRACT

Systems and methods for providing private access to third-party applications include responsive to execution of a third-party application on a mobile device, transmitting a pre-login tunnel request to the cloud-based system; responsive to receiving a signed certificate from the cloud-based system, establishing a pre-login tunnel to one or more pre-login endpoints of the third-party application; performing authentication to the third-party application via the pre-login tunnel; and responsive to receiving a second signed certificate from the cloud-based system, establishing a post-login tunnel to one or more post-login endpoints of the third-party application.

### FIELD OF THE DISCLOSURE

The present disclosure generally relates to network and cloud security. More particularly, the present disclosure relates to systems and methods for providing private access to third-party applications.

### BACKGROUND OF THE DISCLOSURE

Traditionally, mobile applications have connected to their backend servers by exposing public-facing APIs over the internet. In this configuration, mobile devices typically initiate direct connections to these publicly accessible endpoints, often secured by standard TLS/SSL certificates. Although this approach has enabled rapid deployment and ease of use, it also raises several security and operational challenges. For example, publicly exposed APIs provide potential targets for attackers seeking to probe for vulnerabilities or intercept sensitive information. Administrators may resort to implementing network firewalls and access controls to reduce attack surfaces; however, these measures can become complex to maintain, particularly as organizations expand their application offerings and user base. Based thereon, the present disclosure provides systems and methods for providing private access to third-party applications via a cloud-based system.

### BRIEF SUMMARY OF THE DISCLOSURE

The present disclosure relates to systems and methods for providing private access to third-party applications. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include responsive to execution of a third-party application on a mobile device, transmitting a pre-login tunnel request to the cloud-based system; responsive to receiving a signed certificate from the cloud-based system, establishing a pre-login tunnel to one or more pre-login endpoints of the third-party application; performing authentication to the third-party application via the pre-login tunnel; and responsive to receiving a second signed certificate from the cloud-based system, establishing a post-login tunnel to one or more post-login endpoints of the third-party application.

The steps can further include providing, by the cloud-based system, a Software Development Kit (SDK) configured to be embedded into the third-party application, wherein the SDK is assigned a Software Development Kit Identifier (SDKId) and an SDK Secret. The steps can include transmitting a pre-login tunnel request to the cloud-based system, the pre-login tunnel request including a challenge and a Hash-based Message Authentication Code (HMAC) computed using the SDK Secret; receiving a signed certificate from the cloud-based system upon successful verification of the HMAC and establishing the pre-login tunnel to one or more pre-login endpoints of the third-party application; obtaining, from a backend server, a digitally signed identity token after user authentication; sending the digitally signed identity token, a certificate signing request, and the SDKId to the cloud-based system; receiving a second signed certificate upon successful verification of the digitally signed identity token; and establishing the post-login tunnel using the second signed certificate, thereby securing post-login endpoints. The steps can include initiating a secret rotation logic including prompting the cloud-based system to verify HMACs using an old secret and returning a new secret to the SDK for subsequent authentications. Establishing the post-login tunnel can include verifying the digitally signed identity token against a public key registered with the cloud-based system for a corresponding SDK instance. The steps can include dynamically routing user traffic through the cloud-based system for comprehensive inspection, threat detection, and policy enforcement. Pre-login endpoints can include functionalities related to user login, credential verification, or any application state prior to successful user authentication, and post-login endpoints can include functionalities that enable access to protected services, data, or account management operations after user authentication.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a diagram representing a high level architecture of the described ZSDK system.

FIG. 6 is a flow diagram of a pre-login tunnel authentication method.

FIG. 7 is a flow diagram of a post-login tunnel creation method.

FIG. 8 is a flowchart of a process for providing private access for third-party applications.

### DETAILED DESCRIPTION OF THE DISCLOSURE

Again, the present disclosure relates to systems and methods for providing private access to third-party applications. Various embodiments include systems and methods that securely embed cloud-based security services directly into third-party mobile and web applications via specialized Software Development Kits (SDKs). By leveraging a dual-tunnel approach, the invention provides seamless protection during both pre-login activities (e.g., login prompts and credential checks) and post-login interactions (e.g., account management and transactions). Each SDK instance is assigned a unique identifier and secret, enabling the creation of mutually authenticated tunnels that protect all data flowing between an application and its backend infrastructure. Importantly, the invention supports secret rotation to maintain robust security over time. By integrating these services and methods into their applications, organizations can ensure continuous threat inspection, granular policy enforcement, and a high level of data protection, all without requiring the user to interact with any standalone agent for secure access.

### § 1.0 Cybersecurity Monitoring and Protection Examples

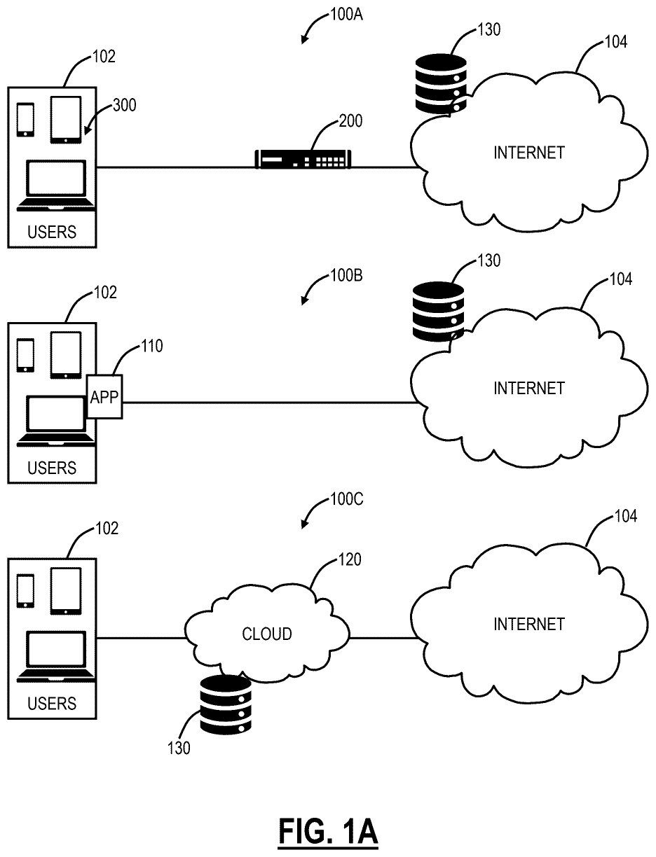

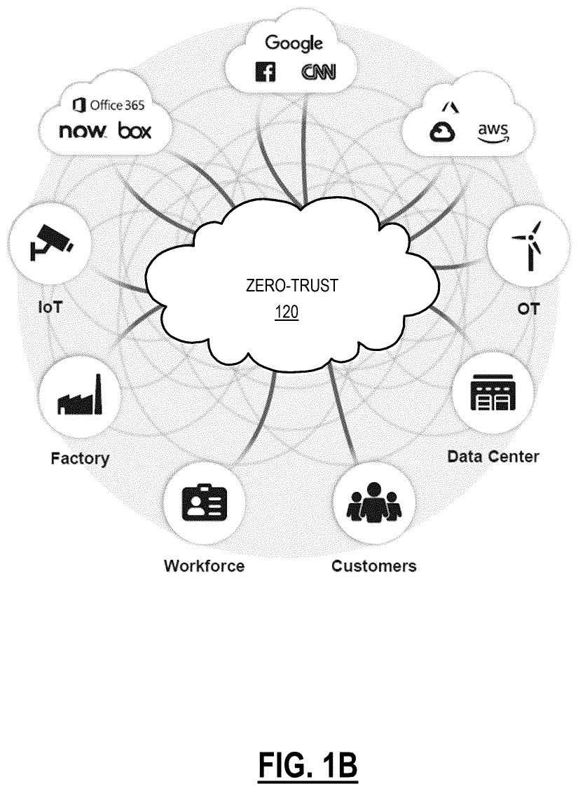

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

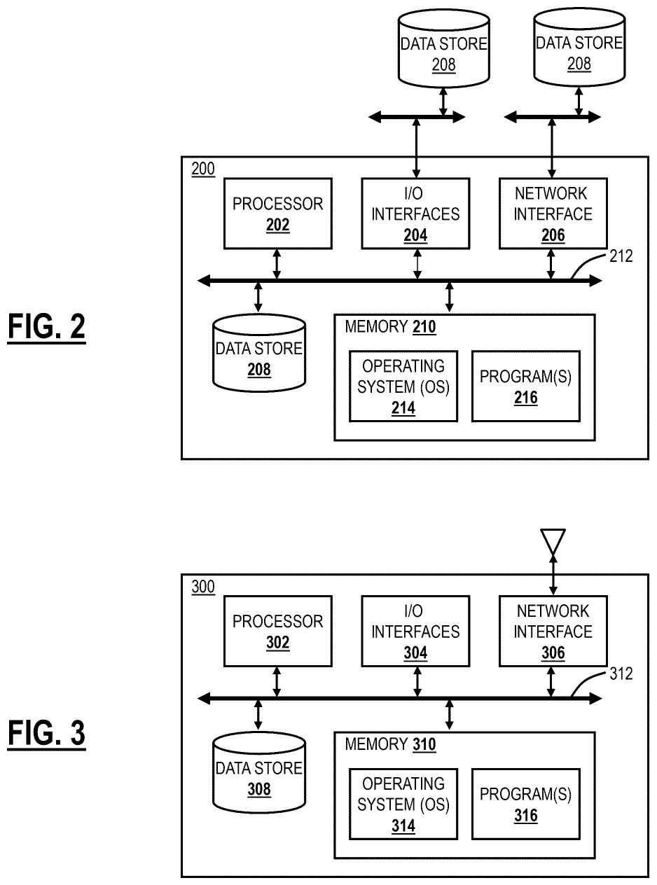

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Pat. No. 8,429,111, issued Apr. 23, 2013, and entitled “Encoding and compression of statistical data,” the contents of which are incorporated herein by reference, describes compression techniques for storing such logs,

Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 Example Server Architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc..

### § 3.0 Example Computing Device Architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 Application for Traffic Forwarding and Monitoring

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

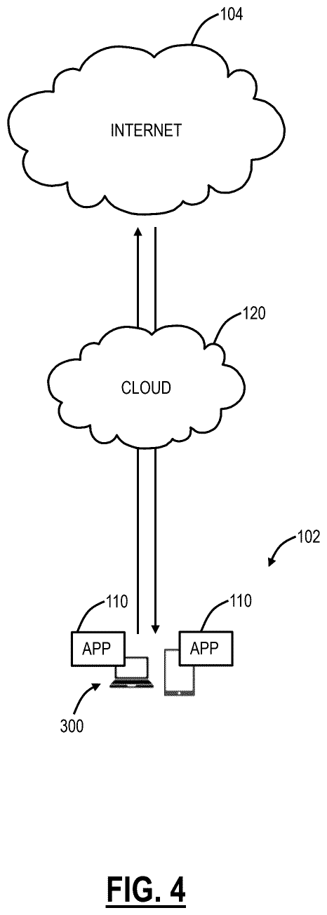

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### § 5.0 Cloud-Based Private Application Access

Zscaler Private Access (ZPA) is a cloud-based service that provides secure, seamless, and scalable access to internal applications without the need for traditional Virtual Private Networks (VPNs). ZPA is designed to enable Zero Trust Network Access (ZTNA), ensuring that users can only access the applications they are explicitly authorized to use. This approach reduces the attack surface, prevents lateral movement, and enhances security by verifying every access request.

ZPA operates on the principle of zero trust, which means that no user or device is trusted by default, even if they are within the network perimeter. Access is granted based on the identity of the user and the context of the request. When a user attempts to access an internal application, ZPA first verifies their identity through integration with an Identity Provider (IDP). Additionally, ZPA can perform device posture checks to ensure that the device meets the organization's security requirements. ZPA uses application discovery to identify and catalog internal applications, deploying connectors within the network that can locate and profile applications without requiring any changes to the applications themselves. Access policies are defined in an admin portal based on user roles, device posture, and other contextual factors. Once authenticated, ZPA dynamically applies these policies to determine whether the user is allowed to access the requested application. If access is granted, the agent application 110 on the user's device establishes a secure connection to an app connector closest to the application. The app connector acts as a broker, creating a micro-tunnel that securely connects the user to the application without exposing the internal network. ZPA optimizes the data path by routing traffic through the closest and most efficient app connector, ensuring low latency and high performance.

The key components of ZPA include the agent application 110, which is installed on the user's device and initiates the connection to ZPA while performing device posture checks. The app connector, deployed within the organization's network, discovers and profiles internal applications and establishes secure micro-tunnels between users and applications. A central authority serves as the policy engine that authenticates users, applies access policies, and orchestrates connections between agent applications 110 and app connectors. The IDP is integrated with ZPA for user authentication, verifying user identities before granting access. The admin portal is the management interface where administrators define access policies, monitor activities, and configure ZPA components.

To set up and provide private access using ZPA, organizations follow a series of steps. Initially, they must deploy app connectors within the network, positioning them close to the applications they will serve to minimize latency. Next, they need to integrate the IDP by configuring ZPA to integrate with the organization's IDP, setting up Single Sign-On (SSO), and configuring authentication protocols like SAML or OAuth. Using the app connectors, organizations discover and profile internal applications by configuring the connectors to scan the network and identify application servers.

In the admin portal, administrators create user and group policies based on user roles, device posture, and other contextual factors. They can set up granular rules for each policy, including conditions for access and any additional security checks required. When users attempt to access an application, ZPA authenticates them through the integrated IDP and performs device posture checks to ensure compliance with security requirements, such as running up-to-date antivirus software or having encryption enabled.

The agent application 110 on the user's device initiates a connection to the cloud 120, which then applies the defined access policies. If the request is authorized, the cloud 120 directs the agent application 110 to the appropriate app connector, and a secure micro-tunnel is established, allowing the user to access the application without exposing the internal network. Administrators use the admin portal to monitor user activity, access attempts, and security events, identifying potential threats and ensuring compliance. They should regularly review and adjust access policies based on evolving security requirements and organizational needs.

By following these steps, organizations can leverage ZPA to provide secure and seamless access to internal applications. ZPA's zero trust approach ensures that only authenticated and authorized users can access specific applications, significantly reducing the risk of unauthorized access and enhancing overall security.

### § 6.0 Private Access for Third-party Applications

With the rapid adoption of cloud services and the increasing need for secure remote access, organizations are continuously looking for solutions that can provide secure, seamless, and scalable connectivity. Traditional security appliances are often inadequate for modern cloud-centric environments, leading to the rise of Secure Access Service Edge (SASE) solutions. Based thereon, the present disclosure describes systems and methods to help organizations integrate cloud-based security and networking capabilities directly into their applications and infrastructure, thus providing enhanced security and performance. These systems and methods provided by Zscaler (the assignee and applicant of the present application) can be referred to as Zscaler Software Development Kit (ZSDK).

ZSDK stands as a comprehensive set of tools and libraries, enabling developers to embed the cloud's advanced security functions directly into their applications, devices, and services. This specialized Software Development Kit (SDK) (ZSDK) provides a seamless way to leverage the described cloud-native security platform, i.e., the cloud 120, which includes capabilities such as Secure Web Gateway (SWG), cloud firewall, Data Loss Prevention (DLP), and Zero Trust Network Access (ZTNA). By integrating ZSDK, organizations can ensure that traffic is securely routed through the cloud 120 for inspection and policy enforcement, providing a robust security layer that supports a wide range of use cases, including secure application access, Internet of Things (IoT) security, and enhanced endpoint protection.

Key features of ZSDK include secure connectivity, which ensures secure and direct connectivity between endpoints and cloud applications. It also includes application integration, allowing developers to integrate the cloud's security services directly into their applications, ensuring that security is built-in rather than bolted on. The scalability of the cloud-native architecture means that security can be consistently applied across all users and devices, no matter where they are located. Granular policy enforcement ensures compliance and protection against threats, while comprehensive visibility and control over network traffic and user activities enable organizations to monitor and manage their security posture effectively.

Integrating ZSDK into an application or environment involves several steps. Initially, organizations need to obtain the specialized SDK (ZSDK) from a portal of the cloud 120 or relevant channels, set up authentication mechanisms to ensure secure access to cloud 120 services, and configure the SDK with necessary parameters such as API keys, endpoints, and security policies. The next step is to embed the SDK into the application or device codebase, following the provided documentation and guidelines. Utilizing the SDK's APIs to route traffic through the cloud involves modifying network configurations to ensure traffic is inspected and secured.

Once integrated, defining and enforcing security policies is crucial. Organizations can set up security policies in an admin portal associated with the cloud 120, specifying rules for traffic inspection, threat prevention, data protection, and access control. These policies must be enforced across all traffic routed through the cloud 120. Thorough testing follows to ensure the integration works as expected and that security policies are correctly applied. Functional testing and security validation are essential to confirm that all traffic is securely routed through the cloud 120 and that any malicious or non-compliant activity is appropriately blocked or mitigated.

Deployment into the production environment occurs after successful testing, followed by continuous monitoring of traffic and security events through the admin portal. This ongoing monitoring ensures compliance and helps identify and respond to any threats. Regular updates to the SDK, i.e. ZSDK, and its configurations are necessary to leverage the latest security features and improvements. Additionally, organizations should regularly review and adjust security policies based on evolving threats and organizational needs.

By following these steps, organizations can effectively integrate the cloud's advanced security capabilities directly into their applications and infrastructure. This integration ensures secure and efficient access to cloud resources while maintaining robust protection against cyber threats. ZSDK is a novel approach to security, aligning with the needs of modern, cloud-centric organizations striving for seamless, scalable, and comprehensive protection.

Thus, as described, ZSDK is a new solution that enables private access, i.e., ZPA, for Business to Customer (B2C) businesses by securely connecting consumer-facing mobile applications to cloud 120 backend services. Consider a mobile banking application that a customer installs on their smartphone to manage bank accounts or perform transactions. Typically, this mobile banking app relies on publicly exposed APIs to communicate with backend servers, which can introduce security risks. With ZSDK, organizations can place these backend APIs behind the cloud 120 ZPA service and embed the ZSDK into their mobile applications. This approach creates a secure tunnel between the mobile app and the backend infrastructure, ensuring that sensitive data remains protected and inaccessible to unauthorized entities. By leveraging ZSDK, businesses not only safeguard their critical services but also provide a seamless and protected user experience for their customers.

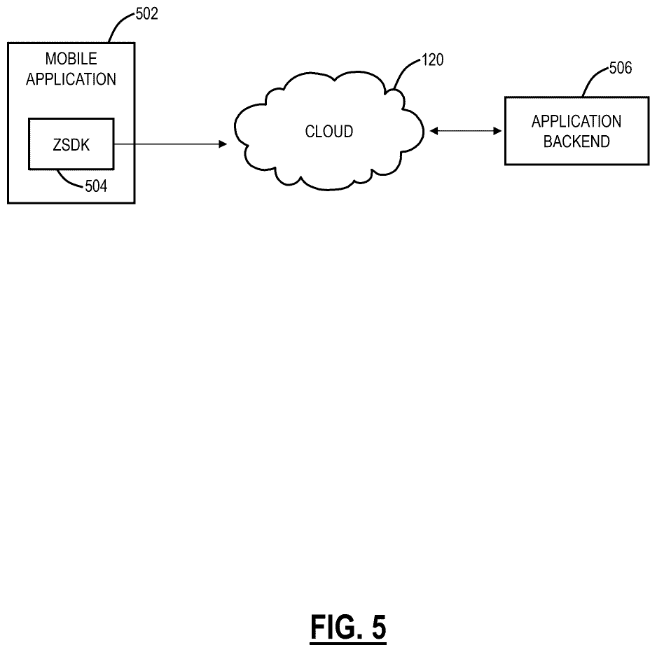

FIG. 5 is a diagram representing a high level architecture of the described ZSDK system. As described herein, a mobile application 502 is equipped with the ZSDK 504. Based thereon, traffic is forwarded through the cloud 120 before it reaches the destination application backend 506. An application backend 506 typically organizes its services into two distinct types of endpoints. The first category, known as “Pre Login Endpoints,” includes all endpoints that users invoke before successfully authenticating. For example, in a mobile banking application scenario, a user signing in with internet banking credentials would interact with APIs responsible for displaying the login page or verifying their username and password. Once the user has been authenticated, the system transitions to “Post Login Endpoints,” which handle requests that occur after successful login. These might include APIs for fetching account balances, initiating money transfers, or other protected banking transactions. Structuring endpoints in this manner, pre-login versus post-login, helps streamline both security protocols and user workflows, ensuring that only authorized individuals can access sensitive operations while enabling a clear, organized path through the authentication process.

In a traditional agent application 110 setup, the user logs into the agent application 110 client using their corporate credentials, which have been preconfigured in the cloud 120 via an Identity Provider (IDP) integration. Upon successful authentication, the cloud 120 signs a certificate that is then used to establish a secure tunnel between the user's device and the cloud 120. This seamless process leverages the user's existing corporate identity and ensures that only authenticated users can connect.

In contrast, when using the ZSDK, the user's identity is not verified by the cloud 120 but rather by a third-party application. This introduces a significant challenge in establishing a tunnel with the cloud 120. Specifically, the issue lies in how to authenticate the ZSDK in both scenarios:

Pre Login Endpoints: These are accessed before any user identity is established, which means the system must handle tunnel creation without knowledge of an authenticated user.

Post Login Endpoints: Although a user identity is known at this stage, it is authenticated by a third-party application rather than by the cloud 120. Consequently, the ZSDK must rely on an alternate mechanism to validate the user and maintain secure connectivity to the cloud 120.

Ultimately, the present systems and methods present a robust authentication model for the ZSDK that accommodates both pre and post-login scenarios, despite the absence of direct user authentication within the cloud 120.

More particularly, the present invention outlines a novel method for authenticating third-party users within a third-party application, enabling the application to securely connect to its backend server through a transport service or product (such as the cloud 120). This secure connection is established using a mutually authenticated SSL tunnel, in which both parties validate each other's identity prior to exchanging any data. By introducing a robust authentication mechanism tailored for third-party environments, the invention ensures that sensitive information remains protected from unauthorized access and that communication between the application and backend server adheres to high security standards.

The solution introduces a dual-tunnel approach that leverages two distinct authentication methods to address different phases of user interaction. The first tunnel, known as the pre-login tunnel, provides secure transport for endpoints that users access before formally logging in. This ensures that even unauthenticated traffic, such as login prompts or credential-verification requests, is protected from potential threats. Once the user has successfully logged in, the solution then employs the post-login tunnel to maintain a secure connection for the authenticated user's subsequent actions, such as viewing account information or performing transactions. By separating the pre-login and post-login traffic into two dedicated tunnels, the solution effectively safeguards sensitive data at all stages of the user journey and creates a more resilient security posture overall.

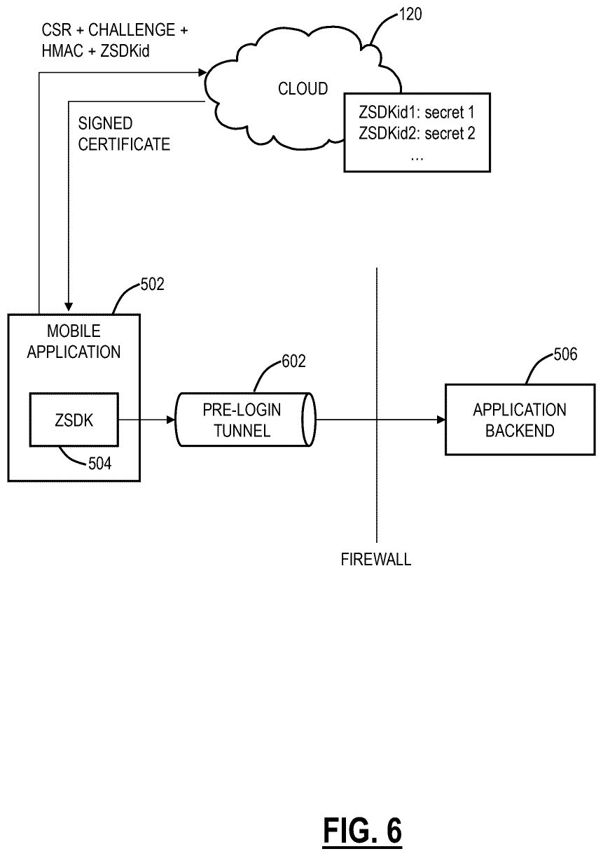

FIG. 6 is a flow diagram of a pre-login tunnel 602 authentication method. To establish secure transport for pre-login endpoints, the ZSDK 504 is provided to customers for integration within their mobile applications as a unique instance. Each instance includes two critical parameters including the ZSDK Identifier (ZSDKId), which is globally unique across the cloud 120, and the ZSDK Secret (Hash-based Message Authentication Code (HMAC) Secret), a randomly generated set of bytes (ranging anywhere from 64 to 256 bytes, though it can be larger or smaller). When a ZSDK 504 instance is created in the cloud 120, it is assigned a specific ZSDKId and a corresponding ZSDK Secret. During runtime, the ZSDK 504 relies on this secret for authentication when setting up the pre-login tunnel. The process begins with the ZSDK 504 creating a 32-64 byte (or larger) challenge and computing an HMAC using the ZSDK Secret. The ZSDKId, this challenge, the resulting HMAC, and a certificate signing request are then transmitted to the cloud 120. The cloud 120 identifies the correct ZSDK Secret based on the ZSDKId and verifies the HMAC on the challenge. Upon successful verification, the cloud 120 returns a signed certificate, which the ZSDK 504 uses to form a mutually authenticated Secure Socket Layer (SSL) tunnel. Through this secure tunnel, the mobile application can safely access all designated pre-login APIs without exposing sensitive data.

To maintain robust security over the lifetime of an application, the ZSDK Secret can be rotated on the backend. When a rotation occurs, both the old secret and the new secret are retained temporarily. During the next authenticated interaction, the ZSDK 504 still uses the old secret to compute its HMAC, which the cloud 120 verifies. Once the verification is successful, the cloud 120 provides the new secret in its response. From that point forward, the ZSDK 504 employs the updated secret for subsequent authentication requests. This rotation process helps safeguard against potential compromises and ensures that the secure tunnel remains continuously protected.

During the setup phase for each ZSDK 504 instance, an additional critical step involves attaching a public key to that instance in the cloud 120. This public key corresponds to the application's backend server private key and is instrumental in creating a secure environment for post-login communication. After a third-party user successfully authenticates via the pre-login tunnel, the backend server issues the ZSDK 504 a digitally signed identity token, signed with the server's private key, to confirm the user's authenticated status. The ZSDK 504 then uses this token to establish a post-login tunnel, ensuring that all subsequent interactions (such as account access and transactions) occur over a mutually authenticated SSL connection.

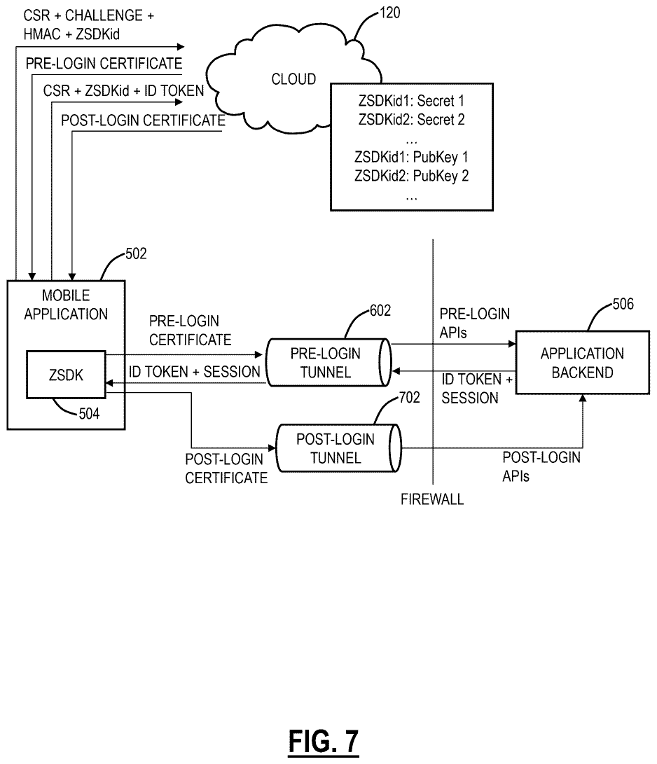

FIG. 7 is a flow diagram of a post-login tunnel 702 creation method. The creation of the post-login tunnel 702 begins when the ZSDK 504 establishes a pre-login tunnel using its HMAC-based ZSDK Secret. Through this tunnel, the third-party user logs in, and the backend server verifies the user's credentials. After successful authentication, the backend server generates a digitally signed identity token (using its private key) and returns it to the ZSDK 504. The ZSDK 504 then produces a Certificate Signing Request (CSR) and sends it, along with the identity token and the ZSDKid, to the cloud 120. Using the ZSDKid, the cloud 120 locates the corresponding public key and verifies the signature of the identity token. Once this verification succeeds, the cloud 120 returns a signed certificate to the ZSDK 504. Finally, the ZSDK 504 employs this signed certificate to establish a mutually authenticated SSL tunnel, ensuring that only properly authenticated users can access post-login endpoints.

By separating the pre-login and post-login phases, the solution safeguards user credentials and application data throughout the authentication lifecycle, maintaining a robust security posture and seamless user experience.

After the post-login tunnel is created in ZSDK 504, several key processes occur to ensure secure, seamless, and efficient access to applications and resources. Once the tunnel is established, all traffic from the user's device intended for protected applications or services is redirected through this secure tunnel, ensuring that it is routed through the cloud security platform, i.e., the cloud 120 and its various security services. As traffic passes through the cloud 120, it undergoes thorough inspection based on predefined security policies. The cloud's security engines analyze the traffic for any signs of threats like malware, phishing attempts, or data leakage, which is crucial for detecting and blocking malicious activities in real-time.

The cloud 120 enforces access control policies defined by the organization, determining which users can access specific applications and resources based on their roles, compliance with security requirements, and contextual factors such as location and device status. DLP policies are also applied to inspect and control sensitive data movement, preventing unauthorized sharing or exfiltration of sensitive information. The tunnel ensures a secure and direct connection between the user's device and the application servers, with the ZSDK 504 using this tunnel to communicate securely, protecting data in transit. The cloud 120 optimizes the data path to ensure low latency and high performance, leveraging its global network of data centers to route traffic through the most efficient path, minimizing delays and enhancing the user experience.

All user activities and access attempts are logged, providing detailed information about who accessed what resources, when, and from where, which is essential for auditing and compliance purposes. The cloud 120 continuously monitors traffic for any suspicious activities, taking automated actions to mitigate risks if threats are detected, such as blocking malicious traffic or isolating compromised devices. The ZSDK 504 ensures that the secure session remains active as long as the user is accessing the protected resources, with session termination occurring if the user becomes inactive or the session duration exceeds predefined limits to ensure security. Depending on the organization's security policies, users may be required to reauthenticate periodically, helping to ensure that only authorized users maintain access to sensitive resources.

The ZSDK 504 is designed to provide a seamless user experience, typically requiring no direct interaction from users once the tunnel is established, making access to applications and resources transparent and uninterrupted. ZSDK 504 supports a wide range of applications, including web-based, client-server, and legacy applications, ensuring that users can access all necessary resources securely, regardless of the application type. By securely routing traffic through the cloud 120, enforcing policies, and continuously monitoring for threats, the present systems and methods ensure that the user's access to applications and resources is both secure and seamless after the post-login tunnel is created.

### § 6.1 Process for Providing Private Access for Third-party Applications

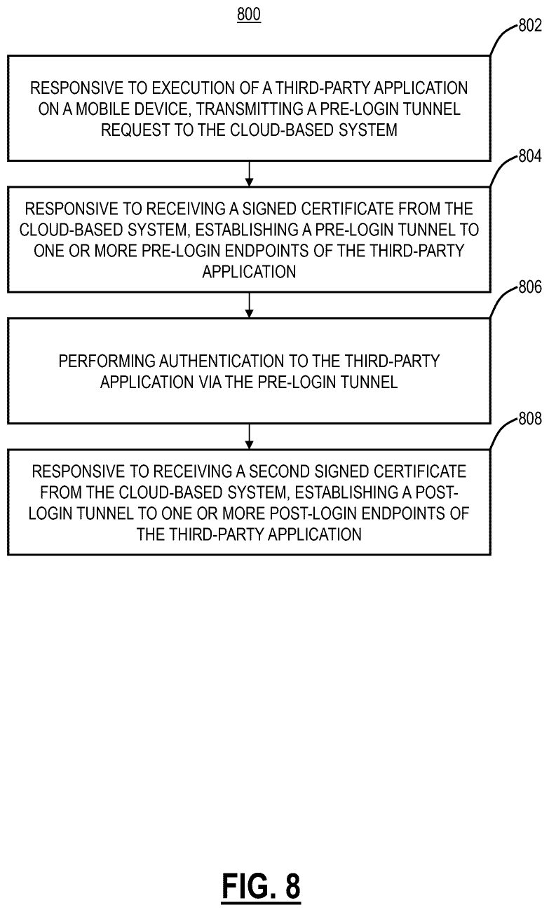

FIG. 8 is a flowchart of a process 800 for providing private access for third-party applications. In various embodiments, the process 800 can be contemplated as a method having steps, a processing device configured to implement the steps, a cloud-based system configured to implement the steps, and as a non-transitory computer-readable medium storing instructions for programming one or more processors to execute the steps. The process 800 includes responsive to execution of a third-party application on a mobile device, transmitting a pre-login tunnel request to the cloud-based system (step 802); responsive to receiving a signed certificate from the cloud-based system, establishing a pre-login tunnel to one or more pre-login endpoints of the third-party application (step 804); performing authentication to the third-party application via the pre-login tunnel (step 806); and responsive to receiving a second signed certificate from the cloud-based system, establishing a post-login tunnel to one or more post-login endpoints of the third-party application (step 808).

The process 800 can further include providing, by the cloud-based system, a Software Development Kit (SDK) configured to be embedded into the third-party application, wherein the SDK is assigned a Software Development Kit Identifier (SDKId) and an SDK Secret. The steps can include transmitting a pre-login tunnel request to the cloud-based system, the pre-login tunnel request including a challenge and a Hash-based Message Authentication Code (HMAC) computed using the SDK Secret; receiving a signed certificate from the cloud-based system upon successful verification of the HMAC and establishing the pre-login tunnel to one or more pre-login endpoints of the third-party application; obtaining, from a backend server, a digitally signed identity token after user authentication; sending the digitally signed identity token, a certificate signing request, and the SDKId to the cloud-based system; receiving a second signed certificate upon successful verification of the digitally signed identity token; and establishing the post-login tunnel using the second signed certificate, thereby securing post-login endpoints. The steps can include initiating a secret rotation logic including prompting the cloud-based system to verify HMACs using an old secret and returning a new secret to the SDK for subsequent authentications. Establishing the post-login tunnel can include verifying the digitally signed identity token against a public key registered with the cloud-based system for a corresponding SDK instance. The steps can include dynamically routing user traffic through the cloud-based system for comprehensive inspection, threat detection, and policy enforcement. Pre-login endpoints can include functionalities related to user login, credential verification, or any application state prior to successful user authentication, and post-login endpoints can include functionalities that enable access to protected services, data, or account management operations after user authentication.

### § 6.0 Processing Circuitry and Non-transitory Computer-readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### § 7.0 Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown in the drawings, descriptions, and claims in a specific order, this does not imply they must be performed in that sequence unless explicitly stated. It also does not imply that all depicted operations are necessary to achieve desirable results. The drawings may schematically represent example processes as flowcharts or diagrams, and additional operations not shown can be included. In the drawings, descriptions, and claims, extra steps can occur before, after, simultaneously with, or between any of the illustrated, described, or claimed steps. Multitasking and parallel processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner—whether collectively, in subsets, or individually—thereby broadening the range of potential embodiments.

What is claimed is:

1. A method for providing private access to third-party applications via a cloud-based system, the method comprising steps of:
responsive to execution of a third-party application on a mobile device, transmitting a pre-login tunnel request to the cloud-based system;
responsive to receiving a signed certificate from the cloud-based system, establishing a pre-login tunnel to one or more pre-login endpoints of the third-party application;
performing authentication to the third-party application via the pre-login tunnel; and
responsive to receiving a second signed certificate from the cloud-based system, establishing a post-login tunnel to one or more post-login endpoints of the third-party application.

2. The method of claim 1, wherein the steps include providing, by the cloud-based system, a Software Development Kit (SDK) configured to be embedded into the third-party application, wherein the SDK is assigned a Software Development Kit Identifier (SDKId) and an SDK Secret.

3. The method of claim 2, wherein the steps include:
transmitting a pre-login tunnel request to the cloud-based system, the pre-login tunnel request including a challenge and a Hash-based Message Authentication Code (HMAC) computed using the SDK Secret;
receiving a signed certificate from the cloud-based system upon successful verification of the HMAC and establishing the pre-login tunnel to one or more pre-login endpoints of the third-party application;
obtaining, from a backend server, a digitally signed identity token after user authentication;
sending the digitally signed identity token, a certificate signing request, and the SDKId to the cloud-based system;
receiving a second signed certificate upon successful verification of the digitally signed identity token; and
establishing the post-login tunnel using the second signed certificate, thereby securing post-login endpoints.

4. The method of claim 3, wherein the steps include initiating a secret rotation logic including prompting the cloud-based system to verify HMACs using an old secret and returning a new secret to the SDK for subsequent authentications.

5. The method of claim 3, wherein establishing the post-login tunnel includes verifying the digitally signed identity token against a public key registered with the cloud-based system for a corresponding SDK instance.

6. The method of claim 1, wherein the steps include dynamically routing user traffic through the cloud-based system for comprehensive inspection, threat detection, and policy enforcement.

7. The method of claim 1, wherein pre-login endpoints include functionalities related to user login, credential verification, or any application state prior to successful user authentication, and post-login endpoints include functionalities that enable access to protected services, data, or account management operations after user authentication.

8. A non-transitory computer-readable medium comprising instructions for providing private access to third-party applications via a cloud-based system that, when executed, cause one or more processors to perform steps of:
responsive to execution of a third-party application on a mobile device, transmitting a pre-login tunnel request to the cloud-based system;
responsive to receiving a signed certificate from the cloud-based system, establishing a pre-login tunnel to one or more pre-login endpoints of the third-party application;
performing authentication to the third-party application via the pre-login tunnel; and
responsive to receiving a second signed certificate from the cloud-based system, establishing a post-login tunnel to one or more post-login endpoints of the third-party application.

9. The non-transitory computer-readable medium of claim 8, wherein the steps include providing, by the cloud-based system, a Software Development Kit (SDK) configured to be embedded into the third-party application, wherein the SDK is assigned a Software Development Kit Identifier (SDKId) and an SDK Secret.

10. The non-transitory computer-readable medium of claim 9, wherein the steps include:
transmitting a pre-login tunnel request to the cloud-based system, the pre-login tunnel request including a challenge and a Hash-based Message Authentication Code (HMAC) computed using the SDK Secret;
receiving a signed certificate from the cloud-based system upon successful verification of the HMAC and establishing the pre-login tunnel to one or more pre-login endpoints of the third-party application;
obtaining, from a backend server, a digitally signed identity token after user authentication;
sending the digitally signed identity token, a certificate signing request, and the SDKId to the cloud-based system;
receiving a second signed certificate upon successful verification of the digitally signed identity token; and
establishing the post-login tunnel using the second signed certificate, thereby securing post-login endpoints.

11. The non-transitory computer-readable medium of claim 10, wherein the steps include initiating a secret rotation logic including prompting the cloud-based system to verify HMACs using an old secret and returning a new secret to the SDK for subsequent authentications.

12. The non-transitory computer-readable medium of claim 10, wherein establishing the post-login tunnel includes verifying the digitally signed identity token against a public key registered with the cloud-based system for a corresponding SDK instance.

13. The non-transitory computer-readable medium of claim 8, wherein the steps include dynamically routing user traffic through the cloud-based system for comprehensive inspection, threat detection, and policy enforcement.

14. The non-transitory computer-readable medium of claim 8, wherein pre-login endpoints include functionalities related to user login, credential verification, or any application state prior to successful user authentication, and post-login endpoints include functionalities that enable access to protected services, data, or account management operations after user authentication.

15. A mobile device comprising:
one or more processors; and
memory storing computer-executable instructions for providing private access to third-party applications via a cloud-based system that, when executed, cause the one or more processors to:
responsive to execution of a third-party application on the mobile device, transmit a pre-login tunnel request to the cloud-based system;
responsive to receiving a signed certificate from the cloud-based system, establish a pre-login tunnel to one or more pre-login endpoints of the third-party application;
perform authentication to the third-party application via the pre-login tunnel; and
responsive to receiving a second signed certificate from the cloud-based system, establish a post-login tunnel to one or more post-login endpoints of the third-party application.

16. The mobile device of claim 15, wherein the third-party application includes a Software Development Kit (SDK), wherein the SDK is assigned a Software Development Kit Identifier (SDKId) and an SDK Secret.

17. The mobile device of claim 16, wherein the instructions cause the one or more processors to:
transmit a pre-login tunnel request to the cloud-based system, the pre-login tunnel request including a challenge and a Hash-based Message Authentication Code (HMAC) computed using the SDK Secret;
receive a signed certificate from the cloud-based system upon successful verification of the HMAC and establish the pre-login tunnel to one or more pre-login endpoints of the third-party application;
obtain, from a backend server, a digitally signed identity token after user authentication;
send the digitally signed identity token, a certificate signing request, and the SDKId to the cloud-based system;
receive a second signed certificate upon successful verification of the digitally signed identity token; and
establish the post-login tunnel using the second signed certificate, thereby securing post-login endpoints.

18. The mobile device of claim 17, wherein the instructions cause the one or more processors to initiate a secret rotation logic including prompting the cloud-based system to verify HMACs using an old secret and returning a new secret to the SDK for subsequent authentications.

19. The mobile device of claim 17, wherein establishing the post-login tunnel includes verifying the digitally signed identity token against a public key registered with the cloud-based system for a corresponding SDK instance.

20. The mobile device of claim 15, wherein the instructions cause the one or more processors to dynamically route user traffic through the cloud-based system for comprehensive inspection, threat detection, and policy enforcement.
